(19) United States
(12) Patent Application Publication
(10) Pub. No.: US 2026/0211768 A1
(43) Pub. Date: Jul. 23, 2026

(54) FAULT-TOLERANT SYSTEM AND METHOD UNDER I2C BUS TOPOLOGY

(71) Applicant: Celestica Technology Consultancy (Shanghai) Co. Ltd, Shanghai (CN)

(72) Inventors: Lingkong Zou, Shanghai (CN); Zhongfu Huang, Shanghai (CN)

(21) Appl. No.: 19/331,906

(22) Filed: Sep. 17, 2025

(30) Foreign Application Priority Data
Jan. 20, 2025 (CN) 2025100914684

(51) Int. Cl. G06F 11/07; G06F 13/40

(52) U.S. Cl. CPC G06F 11/0793; G06F 11/0745; G06F 13/40; G06F 2213/0016

(57) ABSTRACT

The present disclosure provides a fault-tolerant system and method under an I2C bus topology, including a master node, a midpoint board, and a plurality of expansion nodes. The master node includes a baseboard management controller, and each of the expansion nodes includes a smart I2C device, an I2C hotswap chip, and a programmable logic device. The baseboard management controller is connected to the programmable logic device and the I2C hotswap chip via an I2C bus, and the programmable logic device is pairwise connected to the I2C hotswap chip and the smart I2C device. The programmable logic device is configured to receive an I2C signal from the baseboard management controller and perform high-low potential conversion on an enable signal of the I2C hotswap chip based on the I2C signal. The I2C hotswap chip controls turning on or off of the smart I2C device based on the enable signal.

### FIELD OF THE INVENTION

The present disclosure belongs to the field of storage and server technologies, and relates to a fault-tolerant system and method under an I2C bus topology.

### BACKGROUND OF THE INVENTION

As a serial communication protocol, the inter-integrated circuit (I2C) bus plays a crucial role in the fields of storage and servers. With features such as simplicity, low cost, and ease of use, the I2C bus has become the preferred solution for connecting various devices. The I2C bus can connect devices such as hard disk drives, power management chips, fans, sensors, and baseboard management controllers (BMC) to achieve data transmission and device management. However, due to the serial characteristic of the I2C bus, once a device on the bus is faulty, for example, hardware failure, software error, or communication collision occurs, the entire bus may enter a hung state. This causes all devices on the I2C bus to malfunction, thereby affecting stability and availability of the entire system. Therefore, how to provide an efficient and reliable I2C bus fault-tolerant mechanism to ensure stability and availability of the system has become an urgent problem to be solved.

### SUMMARY OF THE INVENTION

The present disclosure aims to provide a fault-tolerant system, method, medium, and electronic device under an I2C bus topology to reduce I2C bus hang.

In a first aspect, the present disclosure provides a fault-tolerant system under an I2C bus topology, including a master node, a midpoint board, and a plurality of expansion nodes, where the master node is connected to the plurality of expansion nodes via the midpoint board, and the plurality of expansion nodes are connected in parallel; and the master node includes a baseboard management controller, and each of the expansion nodes includes a smart I2C device, an I2C hotswap chip, and a programmable logic device, where the baseboard management controller is connected to the programmable logic device and the I2C hotswap chip via an I2C bus, and the programmable logic device is pairwise connected to the I2C hotswap chip and the smart I2C device; the programmable logic device is configured to receive an I2C signal from the baseboard management controller and perform high-low potential conversion on an enable signal of the I2C hotswap chip based on the I2C signal; and the I2C hotswap chip controls turning on or off of the smart I2C device based on the enable signal.

In an implementation of the first aspect, the master node further includes a plurality of hotswap buffers, a central processing unit, and a power supply; and input terminals of the plurality of hotswap buffers are connected to a plurality of I2C interfaces of the baseboard management controller, and output terminals of the plurality of hotswap buffers are connected to the plurality of expansion nodes via the midpoint board.

In an implementation of the first aspect, the I2C interfaces of the baseboard management controller include a first I2C interface and a second I2C interface, and the I2C signal comprises a first I2C signal and a second I2C signal; the first I2C interface is configured to output the first I2C signal, the second I2C interface is configured to output the second I2C signal, and the hotswap buffers include a first hotswap buffer and a second hotswap buffer.

In an implementation of the first aspect, the first I2C signal is input to programmable logic devices on the plurality of expansion nodes via the first hotswap buffer, and the second I2C signal is input to I2C hotswap chips on the plurality of expansion nodes via the second hotswap buffer.

In an implementation of the first aspect, the midpoint board includes a connector for relaying interconnection signals between the plurality of expansion nodes, and the master node is connected to the plurality of expansion nodes via the connector.

In an implementation of the first aspect, the smart I2C device includes an I2C master device and an I2C slave device, and the I2C slave device is configured to obtain an address signal via the midpoint board.

In an implementation of the first aspect, the programmable logic device includes an input terminal and control terminals; the input terminal of the programmable logic device is configured to receive the first I2C signal sent by the baseboard management controller, and one of the control terminals of the programmable logic device is configured to replace an enable terminal of the I2C hotswap chip based on the first I2C signal to turn on or off the smart I2C device.

In an implementation of the first aspect, the I2C hotswap chip includes an input terminal and an output terminal, the input terminal of the I2C hotswap chip is configured to receive the second I2C signal sent by the baseboard management controller, and the I2C hotswap chip turns on or off the smart I2C device based on one of the control terminals of the programmable logic device and the second I2C signal.

In a second aspect, the present disclosure provides a fault-tolerant method under an I2C bus topology, applied to the above fault-tolerant system, including: sequentially turning off, by a master node, smart I2C devices on a plurality of expansion nodes to disconnect the smart I2C devices from an I2C bus, where when the I2C bus resumes from hang after a smart I2C device on a current expansion node is disconnected, the smart I2C device on the current expansion node is abnormal.

In an implementation of the second aspect, the fault-tolerant method under the I2C bus topology further includes: when the I2C bus remains in a hung state after the master node disconnects all the smart I2C devices on the plurality of expansion nodes, sequentially turning on, by the master node, the smart I2C devices on the plurality of expansion nodes to reconnect the smart I2C devices to the I2C bus, where when the I2C bus resumes from hang after a smart I2C device on a current expansion node is turned on, the smart I2C device on the current expansion node is abnormal. As described above, the fault-tolerant system, method, medium, and electronic device under the I2C bus topology according to the present disclosure have the following beneficial effects:
The fault-tolerant system under the I2C bus topology according to the present disclosure controls the smart I2C device on the expansion node through the baseboard management controller on the master node, and performs corresponding enable signal conversion on the programmable logic device and the I2C hotswap chip through the I2C signal sent by the baseboard management controller, to achieve turning on and off of the smart I2C device. The fault-tolerant system under the I2C bus topology according to the present disclosure can automatically diagnose and repair the function of the I2C bus through the baseboard management controller when the smart I2C device on the expansion node hangs.

### BRIEF DESCRIPTION OF DRAWINGS

FIG. 1 shows a schematic structural diagram of a fault-tolerant system under an I2C bus topology according to an embodiment of the present disclosure.

FIG. 2 shows a schematic structural diagram of a fault-tolerant system under an I2C bus topology according to an embodiment of the present disclosure.

FIG. 3 shows a schematic structural diagram of a fault-tolerant system under an I2C bus topology according to an embodiment of the present disclosure.

FIG. 4 shows a schematic structural diagram of a fault-tolerant system under an I2C bus topology according to an embodiment of the present disclosure.

FIG. 5 shows a schematic structural diagram of a fault-tolerant system under an I2C bus topology according to an embodiment of the present disclosure.

FIG. 6 shows a schematic structural diagram of a fault-tolerant system under an I2C bus topology according to an embodiment of the present disclosure.

FIG. 7 shows a schematic structural diagram of a fault-tolerant system under an I2C bus topology according to an embodiment of the present disclosure.

FIG. 8 shows a schematic structural diagram of a fault-tolerant system under an I2C bus topology according to an embodiment of the present disclosure.

### DETAILED DESCRIPTION OF THE INVENTION

The following describes the embodiments of the present disclosure through specific examples. Those skilled in the art can easily understand other advantages and effects of the present disclosure from the content disclosed in this specification. The present disclosure can also be implemented or applied through other different embodiments, and various details in this specification can be modified or changed based on different viewpoints and applications without departing from the spirit of the present disclosure. It should be noted that, in the absence of conflict, the following embodiments and features in the embodiments can be combined with each other.

It should be noted that the drawings provided in the following embodiments are only illustrative of the basic concept of the present disclosure. The drawings only show components related to the present disclosure and are not drawn according to the number, shape, and size of components during actual implementation. The pattern, number, and proportion of components during actual implementation of the present disclosure can be changed arbitrarily, and the layout pattern of components in the present disclosure may be more complex.

As a serial communication protocol, the I2C bus plays a crucial role in the fields of storage and servers. With features such as simplicity, low cost, and ease of use, the I2C bus has become the preferred solution for connecting various devices. The I2C bus can connect devices such as hard disk drives, power management chips, fans, sensors, and baseboard management controllers to achieve data transmission and device management. However, due to the serial characteristic of the I2C bus, once a device on the bus is faulty, for example, hardware failure, software error, or communication collision occurs, the entire bus may enter a hung state. This causes all devices on the I2C bus to malfunction, thereby affecting stability and availability of the entire system.

When a CPU node (or, master node) in a storage server system accesses a smart I2C device, for example, 1) when the smart I2C device performs a hardware reset operation or an interface of the smart I2C device is abnormal during access by the CPU node, 2) when the smart I2C device performs a firmware update or a firmware reset operation during access by the CPU node, or 3) when the smart I2C device experiences firmware hang during access by the CPU node, the characteristics of the smart I2C device may cause the I2C bus hang. Because the smart I2C device cannot recover from the bus hang caused by the characteristics of the smart I2C device, the I2C topology system needs to be designed with a dynamic fault diagnosis and correction mechanism. Therefore, how to provide an efficient and reliable I2C bus fault-tolerant mechanism to ensure stability and availability of the system has become an urgent problem to be solved.

At least for the above problems, the following embodiments of the present disclosure provide a fault-tolerant system, method, medium, and electronic device under an I2C bus topology. The following will describe in detail the technical solutions in the embodiments of the present disclosure with reference to the accompanying drawings in the embodiments of the present disclosure.

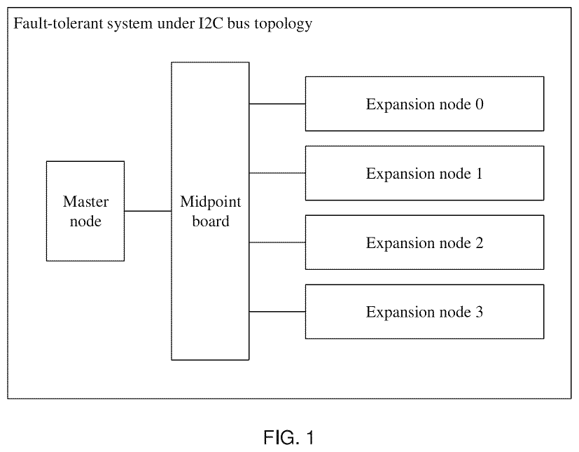

FIG. 1 shows a schematic structural diagram of a fault-tolerant system under an I2C bus topology according to an embodiment of the present disclosure. As shown in FIG. 1, the fault-tolerant system under the I2C bus topology includes a master node, a midpoint board (represented as MP board), and a plurality of expansion nodes. The master node is connected to the plurality of expansion nodes via the midpoint board, and the plurality of expansion nodes are connected in parallel.

For example, the expansion nodes include an expansion node 0 (Node 0), an expansion node 1 (Node 1), an expansion node 2 (Node 2), and an expansion node 3 (Node 3). The number of expansion nodes can be appropriately expanded according to the needs of the chassis, which is not limited in the present disclosure.

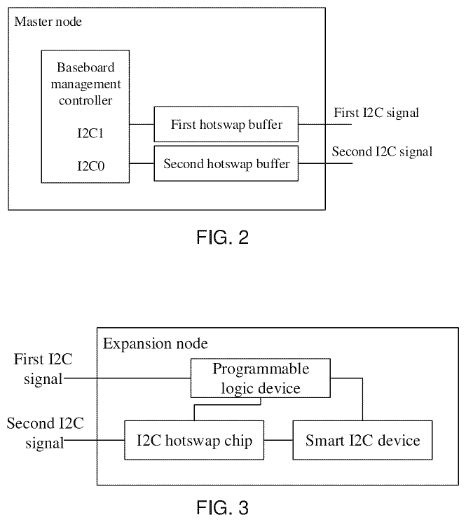

Referring to FIG. 2, the master node includes a baseboard management controller and a plurality of hotswap buffers. Input terminals of the plurality of hotswap buffers are connected to a plurality of I2C interfaces of the baseboard management controller, and output terminals of the plurality of hotswap buffers are connected to the plurality of expansion nodes via the midpoint board. Furthermore, the master node further includes a central processing unit and a power supply.

Referring to FIG. 3, each of the expansion nodes includes a smart I2C device, an I2C hotswap chip, and a programmable logic device. The smart I2C device is a smart chip with built-in firmware, a microprocessor, and a plurality of I2C interfaces. The baseboard management controller on the master node is connected to smart I2C devices on the expansion nodes Node 0, 1 . . . 3 via an I2C bus of the baseboard management controller and the hotswap buffers.

For example, the smart I2C device is a PCIe switch chip, the I2C hotswap chip is a PCA9511, the programmable logic device is a CPLD/FPGA, and the baseboard management controller is a SAS/PCIe switch chip with SES function. The programmable logic device, the baseboard management controller, and the smart I2C device contain firmware.

The baseboard management controller is connected to the programmable logic device and the I2C hotswap chip via an I2C bus, and the programmable logic device is pairwise connected to the I2C hotswap chip and the smart I2C device. The programmable logic device is configured to receive an I2C signal from the baseboard management controller and perform high-low potential conversion on an enable signal of the I2C hotswap chip based on the I2C signal. The I2C hotswap chip controls turning on and off of the smart I2C device based on the enable signal.

From the above description, it can be seen that the fault-tolerant system under the I2C bus topology according to the present disclosure controls the smart I2C device on the expansion node through the baseboard management controller on the master node, and performs corresponding enable signal conversion on the programmable logic device and the I2C hotswap chip through the I2C signal sent by the baseboard management controller, to achieve turning on and off of the smart I2C device. The fault-tolerant system under the I2C bus topology according to the present disclosure can automatically diagnose and repair the function of the I2C bus through the baseboard management controller when the smart I2C device on the expansion node hangs. In addition, the present disclosure enhances the fault-tolerant capability of I2C topology applications through the joint design of hardware and firmware, enabling the system to have dynamic fault diagnosis and correction capabilities. Through the hardware and firmware design of the baseboard management controller and the programmable logic device, when the smart I2C device on the expansion node hangs, the baseboard management controller automatically diagnoses the fault and repairs the function of the I2C bus, allowing the system to continue operating without the shutdown and restart of the full system.

In an embodiment of the present disclosure, the midpoint board includes a connector for relaying interconnection signals between the plurality of expansion nodes, and the master node is connected to the plurality of expansion nodes via the connector.

In an embodiment of the present disclosure, the I2C interfaces of the baseboard management controller include a first I2C interface, referred to as I2C1, and a second I2C interface, referred to as I2C0. The I2C signal sent by the baseboard management controller includes a first I2C signal, referred to as BMC_I2C1, and a second I2C signal, referred to as BMC_I2C0. The first I2C interface is configured to output the first I2C signal, and the second I2C interface is configured to output the second I2C signal. The hotswap buffers include a first hotswap buffer and a second hotswap buffer.

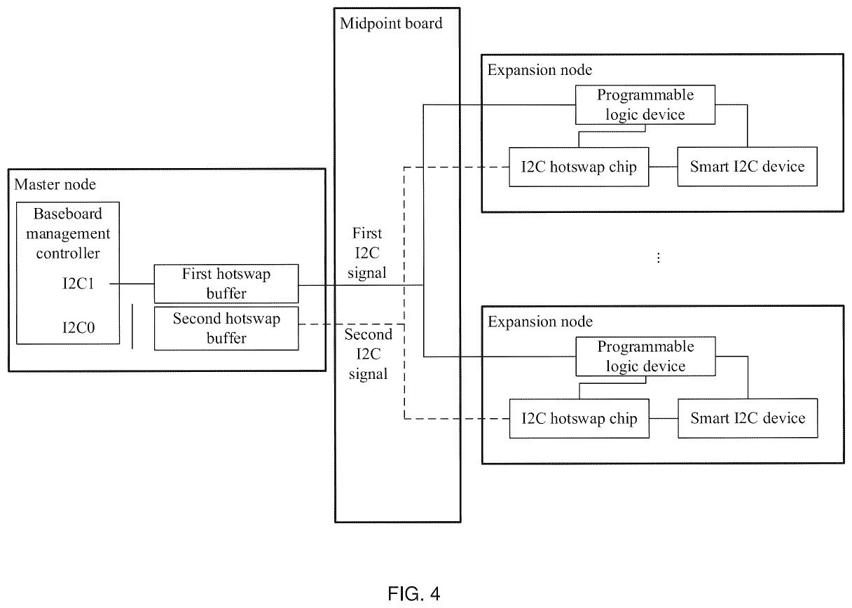

FIG. 4 shows a schematic structural diagram of a fault-tolerant system under an I2C bus topology according to an embodiment of the present disclosure. As shown in FIG. 4, the first I2C signal is input to programmable logic devices on the plurality of expansion nodes via the first hotswap buffer, and the second I2C signal is input to I2C hotswap chips on the plurality of expansion nodes via the second hotswap buffer.

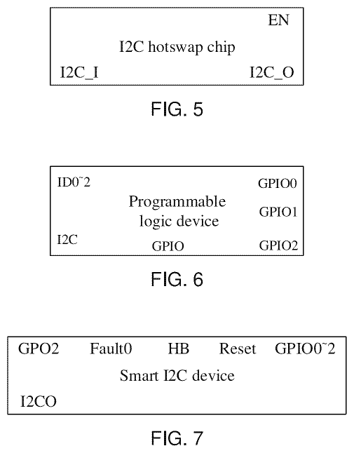

Referring to FIG. 5, the I2C hotswap chip includes an input terminal and an output terminal, the input terminal of the I2C hotswap chip is configured to receive the second I2C signal sent by the baseboard management controller, and the I2C hotswap chip turns on or off the smart I2C device based on a control terminal of the programmable logic device and the second I2C signal.

Referring to FIG. 6, the programmable logic device includes an input terminal and control terminals consisting of a first control terminal, a second control terminal, a third control terminal, and a fourth control terminal. The input terminal of the programmable logic device is configured to receive the first I2C signal sent by the baseboard management controller, and the first control terminal of the programmable logic device is configured to control an enable terminal of the I2C hotswap chip based on the first I2C signal to turn on or off the smart I2C device.

Still referring to FIG. 5, the I2C hotswap chip has three interfaces: the input terminal, the output terminal, and the enable terminal. The input terminal of the I2C hotswap chip is connected to the baseboard management controller on the master node via the midpoint board and is configured to receive the second I2C signal sent by the baseboard management controller. The output terminal of the I2C hotswap chip is connected to the smart I2C device and is configured to perform turning on and off operations on the smart I2C device. The enable terminal of the I2C hotswap chip is configured to control turning on and off of the smart I2C device. When the enable terminal of the I2C hotswap chip is set to 1 (high potential), the I2C hotswap chip is connected to the smart I2C device. When the enable terminal of the I2C hotswap chip is set to 0 (low potential), the I2C hotswap chip is disconnected from the smart I2C device.

As an example, the I2C hotswap chip is an I2C Hotswap IC, the enable terminal is referred to as EN, the input terminal is referred to as I2C_I, and the output terminal is referred to as I2C_O. The baseboard management controller sends the second I2C signal BMC_I2C0 through the second I2C interface. The I2C bus of the baseboard management controller includes an I2C0 bus and an I2C1 bus. This second I2C signal passes through the second hotswap buffer and the I2C0 bus and is transmitted via the midpoint board to input terminals I2C_I of the I2C hotswap chips on the plurality of expansion nodes. When the second I2C signal BMC_I2C0 is a turn-on command, the I2C hotswap chip is connected to the smart I2C device, so that the second I2C signal BMC_I2C0 can access the smart I2C device on the expansion node. When the second I2C signal BMC_I2C0 is a turn-off command, the I2C hotswap chip is disconnected from the smart I2C device, so that the control signal (i.e., the second I2C signal BMC_I2C0) cannot access the smart I2C device.

In some embodiments, the programmable logic device has an address terminal, the input terminal, the first control terminal, the second control terminal, the third control terminal, and the fourth control terminal. The address terminal of the programmable logic device is connected to the midpoint board and is configured to obtain an address of the programmable logic device of the expansion node. The input terminal of the programmable logic device is connected to the baseboard management controller on the master node via the midpoint board and is configured to receive the first I2C signal sent by the baseboard management controller. The first control terminal of the programmable logic device is connected to the enable terminal of the I2C hotswap chip and is configured to send a high or low potential signal to set the enable terminal of the I2C hotswap chip to 1 or 0. The second control terminal of the programmable logic device is connected to a hard reset terminal of the smart I2C device and is configured to control the smart I2C device to perform a hard reset operation. The third control terminal of the programmable logic device is connected to a soft reset terminal of the smart I2C device and is configured to control the smart I2C device to perform a soft reset operation. In addition, the third control terminal of the programmable logic device is connected to a detection terminal of the smart I2C device and is configured to detect a square wave signal sent by the smart I2C device. The fourth control terminal of the programmable logic device is connected to an output terminal of the smart I2C device and is configured to receive a fault correction signal sent by the smart I2C device.

As an example, the address terminal of the programmable logic device is referred to as ID0\tilde{ }2, the input terminal is referred to as I2C, the first control terminal is referred to as GPIO, the second control terminal is referred to as GPIO0, the third control terminal is referred to as GPIO1, and the fourth control terminal is referred to as GPIO2. The output terminal of the smart I2C device is referred to as GPO2, the soft reset terminal is referred to as fault0, the detection terminal is referred to as HB, and the hard reset terminal is referred to as reset. The baseboard management controller sends the first I2C signal BMC_I2C1 through the first I2C interface. This first I2C signal passes through the first hotswap buffer and the I2C1 bus and is transmitted via the midpoint board to the input terminals I2C of the programmable logic devices on the plurality of expansion nodes. Each of the programmable logic device receives a control instruction sent by the first I2C signal and performs high-low potential conversion on the enable terminal of the corresponding I2C hotswap chip through the first control terminal GPIO. When the first I2C signal sends a turn-on command to the programmable logic device, the first control terminal GPIO of the programmable logic device sets the enable terminal of the I2C hotswap chip to high potential, at which time, the control signal (i.e., the second I2C signal BMC_I2C0) received by the input terminal I2C_I of the I2C hotswap chip is transmitted to the output terminal I2C_O, and the I2C hotswap chip is in a turned on state. In this case, the control signal can access the smart I2C device through the I2C hotswap chip. When the first I2C signal BMC_I2C1 sends a turn-off command to the programmable logic device, the first control terminal GPIO of the programmable logic device sets the enable terminal of the I2C hotswap chip to low potential, at which time, the input terminal I2C_I of the I2C hotswap chip is disconnected from the output terminal I2C_O of the I2C hotswap chip, and the I2C hotswap chip is in a turned off state. In this case, the second I2C signal BMC_I2C0 cannot access the smart I2C device on the expansion node.

Referring to FIG. 7, the smart I2C device further includes an input terminal and an address terminal. The input terminal of the smart I2C device is connected to the output terminal of the I2C hotswap chip and is configured to receive a turn-on or turn-off signal sent by the I2C hotswap chip. The address terminal of the smart I2C device is connected to the midpoint board and is configured to obtain an address of the smart I2C device of the expansion node.

As an example, the input terminal of the smart I2C device is referred to as I2CO, and the address terminalis referred to as GPIO0\tilde{ }2. Address terminals GPIO0\tilde{ }2 of the smart I2C devices on the plurality of expansion nodes are connected to the midpoint board, and addresses of the smart I2C devices are obtained through high and low potentials on the midpoint board. The input terminal I2CO of the smart I2C device is connected to the I2C hotswap chip and is configured to receive the second I2C signal BMC_I2C0 through the I2C hotswap chip.

In some embodiments, the baseboard management controller on the master node is connected to the smart I2C devices on the plurality of expansion nodes via the I2C bus and the I2C hotswap buffers. In addition, the programmable logic devices on the plurality of expansion nodes control turning on and off of the I2C hotswap chips on the expandable nodes through GPIO terminals. If the programmable logic device on the current expansion node sets the enable terminal of the I2C hotswap chip on the current expansion node to high potential (EN=1) through a GPIO signal from the GPIO terminal of the programmable logic device, the I2C hotswap chip is turned on, and the second I2C signal BMC_I2C0 is sent from the I2C bus of the baseboard management controller to the smart I2C device on the current expansion node. If the programmable logic device on the current expansion node sets the enable terminal of the I2C hotswap chip on the current expansion node to low potential (EN=0) through the GPIO signal, the I2C hotswap chip is turned off, and the I2C bus of the baseboard management controller is disconnected from the smart I2C device on the current expansion node.

In an embodiment of the present disclosure, the smart I2C device includes an I2C master device and an I2C slave device, and the smart I2C device includes a plurality of I2C interfaces. The I2C master device or the I2C slave device may be configured based on the I2C interfaces. The I2C slave device is configured to obtain an address signal via the midpoint board. The programmable logic devices and the smart I2C devices on the plurality of expansion nodes can determine location identity (ID) information of the expansion nodes in the chassis based on ID signals and set corresponding I2C addresses to avoid conflicts.

For example, the expansion nodes Node 0, 1 . . . 3 can determine ID information of the expansion nodes in the chassis based on the ID signals and set corresponding I2C addresses to avoid address conflicts. When a smart I2C device on the expansion node 0 detects that the address terminal GPIO0\tilde{ }2 (the address terminal of the corresponding programmable logic device is ID0\tilde{ }2) of the smart I2C device is 000 (0 is logic low potential, and 1 is logic high potential), the firmware of the smart I2C device sets an address of the I2C slave device of the I2CO interface (i.e., the input terminal I2CO) of the smart I2C device to 0x2A. When a smart I2C device on the expansion node 0 detects that the address terminal GPIO0\tilde{ }2 is 001, the firmware of the smart I2C device sets the I2CO interface to 0x28. During normal operation, the baseboard management controller communicates with the smart I2C devices on the plurality of expansion nodes via the I2C bus and the hotswap buffers. When detecting that the I2C bus hangs, the baseboard management controller first diagnoses the smart I2C devices on the expansion nodes to determine which I2C slave device on the bus is faulty and then performs fault correction on the faulty device.

The present disclosure also provides a fault-tolerant method under an I2C bus topology, including: sequentially turning off, by a master node, smart I2C devices on a plurality of expansion nodes to disconnect the smart I2C devices from the I2C bus, where if the I2C bus resumes from hang after a smart I2C device on a current expansion node is disconnected, the smart I2C device on the current expansion node is abnormal.

In an embodiment of the present disclosure, the fault-tolerant method under the I2C bus topology further includes: if the I2C bus remains in a hung state after the master node disconnects all the smart I2C devices on the plurality of expansion nodes, sequentially turning on, by the master node, the smart I2C devices on the plurality of expansion nodes to reconnect the smart I2C devices to the I2C bus, where if the I2C bus resumes from hang after a smart I2C device on a current expansion node is connected, the smart I2C device on the current expansion node is abnormal.

In an embodiment of the present disclosure, the diagnostic process for a single expansion node is as follows: When I2C bus hang occurs on the single expansion node, the expansion node is disconnected to check whether the I2C bus recovers. If the I2C bus recovers, the expansion node is reconnected to confirm whether the I2C bus is normal. If the I2C bus remains in a normal state, it indicates that the smart I2C device on the expansion node is faulty.

Specifically, the diagnostic process when a single expansion node is faulty is as follows: When I2C bus hang occurs on the single expansion node, the master node sends turn-off signals to expansion nodes 0-3 via a midpoint board, to turn off smart I2C devices on the expansion nodes. First, the master node sends a turn-off signal to the expansion node 0. A baseboard management controller sends an I2C0 signal (i.e., the second I2C signal BMC_I2C0) through an I2C0 interface (i.e., the second I2C interface I2C0) and an I2C1 signal (i.e., the first I2C signal BMC_I2C1) through an I2C1 interface (i.e., the first I2C interface I2C1). The I2C1 signal passes through a first hotswap buffer and an I2C1 bus to an input terminal I2C of a programmable logic device. The I2C0 signal passes through a second hotswap buffer and an I2C0 bus to an input terminal I2C_I of an I2C hotswap chip. After receiving the turn-off signal, the programmable logic device of the expansion node 0 sets an enable terminal of the corresponding I2C hotswap chip to low potential through a first control terminal GPIO of the programmable logic device, while enable terminals of I2C hotswap chips on the other expansion nodes remain at high potential. In this case, an input terminal I2C_I of the I2C hotswap chip is disconnected from I2C_O, and the I2C hotswap chip is in a turned off state, at which time, the baseboard management controller cannot access the smart I2C device on the expansion node 0. If the I2C bus resumes from hang after the smart I2C device on the expansion node 0 is turned off, it indicates that the smart I2C device on the expansion node 0 is faulty.

Further, when it is determined that the smart I2C device on the expansion node 0 is faulty, the smart I2C device on the expansion node 0 needs to be reset.

Specifically, the diagnostic process when a plurality of expansion nodes are faulty is as follows: First, the master node sends a turn-off signal to an expansion node 0. The baseboard management controller sends an I2C0 signal through an I2C0 interface and an I2C1 signal through an I2C1 interface. The I2C1 signal passes through a first hotswap buffer and an I2C1 bus to an input terminal I2C of a programmable logic device on the expansion node 0. The I2C0 signal passes through a second hotswap buffer and an I2C0 bus to an input terminal I2C_I of the I2C hotswap chip on the expansion node 0. After receiving the turn-off signal, the programmable logic device sets an enable terminal of the I2C hotswap chip to low potential through a first control terminal GPIO of the programmable logic device, while enable terminals of I2C hotswap chips on other expansion nodes remain at high potential. In this case, the baseboard management controller only accesses the expansion node 0 and does not access the expansion nodes 1-3. In this case, an input terminal I2C_I of the I2C hotswap chip on the expansion node 0 is disconnected from I2C_O, and the I2C hotswap chip is in a turned off state, at which time, the baseboard management controller cannot access the smart I2C device on the expansion node 0. If the I2C bus remains in a hung state after the smart I2C device on the expansion node 0 is turned off, the baseboard management controller on the master node continues to send a turn-off signal to the expansion node 1. Through the above process, a smart I2C device on the expansion node 1 is turned off. If the I2C bus remains in the hung state after the smart I2C device on the expansion node 1 is turned off, the disconnection of a smart I2C device on the expansion node 2 is performed. If the I2C bus resumes from hang after the smart I2C device on the expansion node 2 is turned off, it indicates that the smart I2C device on the expansion node 2 is faulty. Then the expansion node 3 does not need to be checked. In this case, the smart I2C device on the expansion node 2 is reset.

Further, if the I2C bus remains in the hung state after all the smart I2C devices on the expansion nodes 0-3 are disconnected, the smart I2C devices on the expansion nodes 0-3 need to be reconnected. If the I2C bus recovers after a smart I2C device on one of the expansion node is restored, it indicates that the smart I2C device on the current expansion node is faulty. The process for the master node to reconnect the smart I2C device on the expansion node is as follows: The master node sends a turn-on signal to the expansion node 0. The baseboard management controller sends an I2C1 signal to the I2C terminal of the programmable logic device of the expansion node 0. After receiving the turn-on signal from the baseboard management controller, the programmable logic device sets the enable terminal of the corresponding I2C hotswap chip to 1 through the GPIO control terminal, while the enable terminals of the I2C hotswap chips on the other expansion nodes remain at 0. In this case, the baseboard management controller only accesses the expansion node 0 and does not access the expansion nodes 1-3. In this case, the input terminal I2C_I of the I2C hotswap chip is reconnected to the output terminal I2C_O, and the I2C0 signal sent by the baseboard management controller can be input to the smart I2C device through the I2C hotswap chip. In this case, the smart I2C device is turned on. If the I2C bus recovers after the smart I2C device on the expansion node 0 is turned on, it indicates that the smart I2C device on the expansion node 0 is faulty, and a reset operation is performed on the smart I2C device. If the I2C bus remains in a hung state after the smart I2C device on the expansion node 0 is turned on, the reconnection of the smart I2C devices on the expansion nodes 1-3 through the above process continues. If the I2C bus resumes from hang after the smart I2C device on the expansion node 2 is reconnected, it indicates that the smart I2C device on the expansion node 2 is faulty, and a reset operation is performed on the smart I2C device on the expansion node 2.

In an embodiment of the present disclosure, when it is determined that a smart I2C device on one of the expansion nodes is faulty, a fault correction operation is performed on the smart I2C device, where the fault correction operation includes a hard reset and a soft reset.

Specifically, the soft reset process for the smart I2C device is as follows: A third control terminal GPIO1 of the programmable logic device sends a signal to a soft reset terminal (fault0 interface) of the smart I2C device to notify the smart I2C device that an I2CO interface of the smart I2C device is faulty. After receiving a soft reset instruction, the smart I2C device resets the I2CO interface while keeping states of other interfaces unchanged. The hard reset process for the smart I2C device is as follows: The baseboard management controller sends a command to the programmable logic device (e.g., a CPLD) of the expansion node via the I2C1 bus, instructing the CPLD to reset the smart I2C device through a GPIO0 pin (i.e., the second control terminal GPIO0). The smart I2C device is reset through the hard reset terminal (reset). During the hard reset, all interfaces of the smart I2C device are reset.

When the smart I2C device is faulty and needs to be restored, the soft reset is performed first. If the soft reset exceeds the response time, the hard reset is performed. The manner of performing a soft reset first followed by a hard reset can minimize the power consumption of the smart I2C device.

For example, when the programmable logic device (CPLD/FPGA) sets the soft reset terminal of the smart I2C device to low potential, it indicates that the CPLD/FPGA reports a fault of the smart I2C device. After receiving the fault signal, the smart I2C device needs to actively reset the I2CO interface. If the smart I2C device does not successfully perform a soft reset or recover within the response time, a hard reset is performed on the smart I2C device.

GPO2 interface of the smart I2C device is an output of the smart I2C device, while GPIO2 interface of the CPLD can serve as both an input and an output. After a successful hard reset, GPO2 interface outputs high potential to the CPLD, indicating that the fault in the smart I2C device has been corrected and the function is restored. In this case, the CPLD can operate the smart I2C device and set the enable pin (i.e., the enable terminal) of the I2C hotswap chip (I2C IC) to 1 through the GPIO pin to turn on the smart I2C device. After a successful hard reset, the smart I2C device can also send a square wave signal to GPIO1 interface of the CPLD through an HB pin, to send an operation status of the smart I2C device to the BMC chip. If the square wave signal is present, it indicates that the smart I2C device is in normal operation. If the square wave signal is absent, it indicates that the I2C device is in an abnormal state.

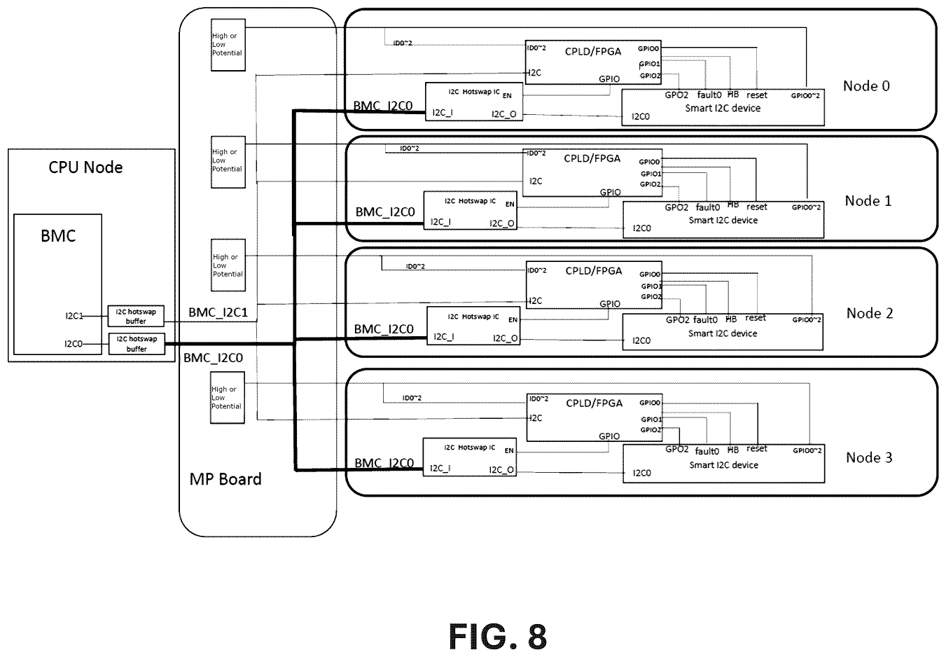

The following will describe in detail the fault-tolerant system and method under the I2C bus topology according to the embodiments of the present disclosure through a specific example. It should be noted that the content in the example is only used to explain and illustrate the fault-tolerant method under the I2C bus topology according to the embodiments of the present disclosure rather than to restrict the scope of the present disclosure. During specific application, corresponding steps can be added or deleted on the basis of the example according to actual needs. FIG. 8 shows a structural diagram of the fault-tolerant system under the I2C bus topology in the example.

The fault diagnosis process for expansion nodes is as follows: A BMC first sets an enable terminal of an I2C hotswap IC (i.e., I2C hotswap chip) on Node 0 to logic low potential (EN=0) through a CPLD/FPGA on Node 0, to disconnect a smart I2C device on Node 0 from I2C0 interface of BMC. In this case, if the smart I2C device on Node 0 is faulty, the other devices on the I2C bus can return to normal after the smart I2C device on Node 0 is disconnected. If the I2C bus remains hung, the BMC continues to set an enable terminal of an I2C hotswap IC on Node 1 to logic low potential (EN=0) through a CPLD/FPGA on Node 1, to disconnect a smart I2C device on Node 1 from I2C0 interface of BMC, and then checks whether the I2C bus is normal. If the I2C bus remains abnormal, the BMC continues to disconnect a smart I2C device on Node 2 from I2C0 interface of BMC. If the I2C bus returns to normal, it can be determined that the smart I2C device on Node 2 is faulty. In this case, the BMC needs to first activate an enable signal of the I2C hotswap IC on Node 0 that is previously deactivated (set the enable terminal to logic high potential (EN=1)), to reconnect the smart I2C device on Node 0 to I2C0 interface of BMC. If the bus remains normal, it indicates that the smart I2C device on Node 0 is not faulty. Following this logic, the verification of whether the smart I2C device on Node 1 is faulty continues. Similarly, I2C hotswap ICs on Node 1 and Node 2 are turned on in sequence to verify whether smart I2C devices on Node 1 and Node 2 are faulty, so as to determine the faulty smart I2C device.

The fault correction process for a smart I2C device on an expansion node is as follows: If the BMC ultimately confirms that one or more smart I2C devices associated with one or more nodes are faulty, the BMC communicates with the corresponding CPLD/FPGA via a first I2C signal BMC_I2C1 and sets GPIO1 of the CPLD/FPGA to logic high potential. In this case, a fault0 signal of the smart I2C device on the node is set to logic high potential (fault0=1), and the smart I2C device can learn that the I2CO interface of the smart I2C device is faulty. In this case, firmware of the smart I2C device performs a soft reset on the I2CO interface. After the soft reset on the interface is completed, the smart I2C device sets a GPO2 signal of the smart I2C device to logic high potential (GPO2=1), allowing the CPLD/FPGA to learn that the reset on the I2CO interface of the smart I2C device is completed. If the smart I2C device does not respond to the fault0 signal reported by the CPLD/FPGA for a long time, the CPLD/FPGA directly performs a hard reset (through a GPIO0 signal of the CPLD/FPGA) on the smart I2C device to enable the I2C0 bus to resume from a hung state. For the definition of non-response time, the CPLD/FPGA sets a time-out of 60 seconds. If the smart I2C device fails to set a GPO2 pin of the smart I2C device to logic high potential within 60 seconds, it is considered a long-time non-response. The hard reset method is as follows: The CPLD/FPGA sets the GPIO0 signal of the CPLD/FPGA to logic high potential for 200 milliseconds and then sets the GPIO0 signal to logic low potential. In this case, a reset pin of the smart I2C device is set to high potential (reset=1) for 200 milliseconds, and a forced hard reset is performed on the smart I2C device. After the smart I2C device is reset and returns to normal, the smart I2C device outputs a 1 KHz square wave signal through an HB pin of the smart I2C device. The CPLD/FPGA detects the square wave signal and learns that the smart I2C device has returned to normal. In this case, the CPLD/FPGA turns on the I2C hotswap chip on the node to reconnect the smart I2C device on the node to I2C0 interface of BMC, allowing the BMC system to perform a normal management function. After an I2C interface of the BMC operates normally, the BMC sets the fault0 signal of the smart I2C device to logic low potential (fault0=0) through the CPLD/FPGA, and the smart I2C device sets the GPO2 signal of the smart I2C device to logic low potential (GPO2=0). In this case, the system operates normally with fault diagnosis and correction capabilities for the next operation.

In summary, in the fault-tolerant method under the I2C bus topology according to the present disclosure, corresponding enable signal conversion is performed on the I2C hotswap chip through the programmable logic device based on the I2C signals sent by the baseboard management controller, to achieve turning on and off of smart I2C devices, thereby allowing for diagnosis of smart I2C devices on expansion nodes to obtain the expansion node causing the I2C bus hang and fault correction for the faulty smart I2C device. The fault-tolerant system under the I2C bus topology according to the present disclosure enables the baseboard management controller to dynamically diagnose and correct faults in the smart I2C devices when the I2C bus hangs, reducing I2C bus hang, improving reliability of the system, and achieving rapid fault localization and repair for the faulty device. In addition, the present disclosure enhances the fault-tolerant capability of I2C topology applications through the joint design of hardware and firmware, enabling the system to have dynamic fault diagnosis and correction capabilities. Through the hardware and firmware design of the baseboard management controller and the programmable logic device, when a smart I2C device on the expansion node hangs, the baseboard management controller automatically diagnoses the fault and repairs the function of the I2C bus, allowing the system to continue operating without the shutdown and restart of the full system.

The scope for the fault-tolerant method under the I2C bus topology according to the embodiments of the present disclosure is not limited to the execution order of steps listed. Any solution implemented by adding, deleting, or replacing steps in the prior art based on the principles of the present disclosure is included in the scope of the present disclosure.

The fault-tolerant system under the I2C bus topology according to the embodiments of the present disclosure can implement the fault-tolerant method under the I2C bus topology according to the present disclosure. However, an implementation apparatus of the fault-tolerant method under the I2C bus topology according to the present disclosure includes but is not limited to the structure of the fault-tolerant system under the I2C bus topology listed. Any structural modification and replacement based on the principles of the present disclosure in the prior art is included in the scope of the present disclosure.

In the several embodiments according to the present disclosure, it should be understood that the disclosed system, apparatus, or method may be implemented in other manners. For example, the apparatus embodiments described above are only illustrative. For example, the division of modules/units is only a logical function division. During actual implementation, there may be other division manners. For example, a plurality of modules or units may be combined or integrated into another system, or some features may be ignored or not implemented. In addition, the displayed or discussed mutual couplings, direct couplings or communication connections may be indirect couplings or communication connections through some interfaces, apparatuses, modules, or units, and may be in electrical, mechanical, or other forms.

The modules/units described as separate components may or may not be physically separated. The components displayed as modules/units may or may not be physical modules, that is, may be located in one place or distributed across a plurality of network units. Some or all of the modules/units may be selected according to actual needs to achieve the purpose of the embodiments of the present disclosure. For example, the functional modules/units in the various embodiments of the present disclosure may be integrated into one processing module, or each module/unit may exist physically alone, or two or more modules/units may be integrated into one module/unit.

Those of ordinary skill in the art should further realize that the units and algorithm steps of the examples described with reference to the embodiments disclosed herein can be implemented in electronic hardware, computer software, or a combination of both. To clearly illustrate the interchangeability of hardware and software, the composition and steps of each example have been generally described in terms of function in the above description. Whether these functions are performed by hardware or software depends on the specific application and design constraints of the technical solution. A skilled person can use different methods for each specific application to implement the described functions, but such implementation should not be considered beyond the scope of the present disclosure.

The descriptions of the processes or structures corresponding to the various figures above have their own emphases. For parts not described in detail in a process or structure, refer to the relevant descriptions of other processes or structures.

The above embodiments are only illustrative of the principles and effects of the present disclosure and are not intended to restrict the present disclosure. Any person skilled in the art can modify or change the above embodiments without departing from the spirit and scope of the present disclosure. Therefore, any equivalent modification or change made by those with ordinary knowledge in the technical field without departing from the spirit and technical ideas disclosed in the present disclosure should still be covered by the present disclosure.

1.-10. (canceled)

11. A fault-tolerant system under an inter-integrated circuit (I2C) bus topology comprising:
a master node comprising a baseboard management controller;
a midpoint board; and
a plurality of expansion nodes each expansion node of the plurality of expansion nodes comprising:
a smart I2C device;
an I2C hotswap chip; and
a programmable logic device,
wherein the master node is connected to the plurality of expansion nodes via the midpoint board,
wherein the plurality of expansion nodes are connected in parallel,
wherein the baseboard management controller is connected to the programmable logic device and the I2C hotswap chip via an I2C bus,
wherein the programmable logic device is pairwise connected to the I2C hotswap chip and the smart I2C device,
wherein the programmable logic device is configured to receive an I2C signal from the baseboard management controller and perform high-low potential conversion on an enable signal of the I2C hotswap chip based on the I2C signal, and
wherein the I2C hotswap chip controls turning on or off of the smart I2C device based on the enable signal.

12. The fault-tolerant system under the I2C bus topology of claim 11, wherein the master node further comprises a plurality of hotswap buffers, a central processing unit, and a power supply, and
wherein input terminals of the plurality of hotswap buffers are connected to a plurality of I2C interfaces of the baseboard management controller, and output terminals of the plurality of hotswap buffers are connected to the plurality of expansion nodes via the midpoint board.

13. The fault-tolerant system under the I2C bus topology of claim 12, wherein the I2C interfaces of the baseboard management controller comprise a first I2C interface and a second I2C interface, and the I2C signal comprises a first I2C signal and a second I2C signal; wherein the first I2C interface is configured to output the first I2C signal, the second I2C interface is configured to output the second I2C signal, and the hotswap buffers comprise a first hotswap buffer and a second hotswap buffer.

14. The fault-tolerant system under the I2C bus topology of claim 13, wherein a first I2C signal is input to programmable logic devices on the plurality of expansion nodes via the first hotswap buffer, and the second I2C signal is input to I2C hotswap chips on the plurality of expansion nodes via the second hotswap buffer.

15. The fault-tolerant system under the I2C bus topology of claim 11, wherein the midpoint board comprises a connector for relaying interconnection signals between the plurality of expansion nodes, and the master node is connected to the plurality of expansion nodes via the connector.

16. The fault-tolerant system under the I2C bus topology of claim 11, wherein the smart I2C device comprises an I2C master device and an I2C slave device, and the I2C slave device is configured to obtain an address signal via the midpoint board.

17. The fault-tolerant system under the I2C bus topology of claim 11, wherein the programmable logic device comprises an input terminal and control terminals,
wherein the input terminal of the programmable logic device is configured to receive a first I2C signal sent by the baseboard management controller, and
wherein one of the control terminals of the programmable logic device is configured to control an enable terminal of the I2C hotswap chip based on the first I2C signal to turn on or off the smart I2C device.

18. The fault-tolerant system under the I2C bus topology of claim 11, wherein the I2C hotswap chip comprises an input terminal and an output terminal,
wherein the input terminal of the I2C hotswap chip is configured to receive a second I2C signal sent by the baseboard management controller, and
wherein the I2C hotswap chip turns on or off the smart I2C device based on one of the control terminals of the programmable logic device and the second I2C signal.

19. A fault-tolerant method under an I2C bus topology, the method comprising:
sequentially turning off, by a master node, smart I2C devices on a plurality of expansion nodes to disconnect the smart I2C devices from an I2C bus,
wherein when the I2C bus resumes from hang after a smart I2C device on a current expansion node of the plurality of expansion nodes is disconnected, the smart I2C device on the current expansion node is abnormal,
wherein the master node comprises a baseboard management controller,
wherein each expansion node of the plurality of expansion nodes comprises:
a smart I2C device;
an I2C hotswap chip; and
a programmable logic device;
wherein the master node is connected to the plurality of expansion nodes via a midpoint board,
wherein the plurality of expansion nodes are connected in parallel,
wherein the baseboard management controller is connected to the programmable logic device and the I2C hotswap chip of each of the plurality of expansion nodes via an I2C bus,
wherein the programmable logic device of each of the plurality of expansion nodes is configured to receive an I2C signal from the baseboard management controller and perform high-low potential conversion on an enable signal of the I2C hotswap chip based on the I2C signal, and
wherein the I2C hotswap chip controls turning on or off of the smart I2C device based on the enable signal.

20. The method of claim 19, wherein the master node further comprises a plurality of hotswap buffers, a central processing unit, and a power supply, and
wherein input terminals of the plurality of hotswap buffers are connected to a plurality of I2C interfaces of the baseboard management controller, and output terminals of the plurality of hotswap buffers are connected to the plurality of expansion nodes via the midpoint board.

21. The method of claim 20, wherein the I2C interfaces of the baseboard management controller comprise a first I2C interface and a second I2C interface, and the I2C signal comprises a first I2C signal and a second I2C signal; wherein the first I2C interface is configured to output the first I2C signal, the second I2C interface is configured to output the second I2C signal, and the hotswap buffers comprise a first hotswap buffer and a second hotswap buffer.

22. The method of claim 21, wherein the first I2C signal is input to programmable logic devices on the plurality of expansion nodes via the first hotswap buffer, and the second I2C signal is input to I2C hotswap chips on the plurality of expansion nodes via the second hotswap buffer.

23. The method of claim 19, wherein the midpoint board comprises a connector for relaying interconnection signals between the plurality of expansion nodes, and the master node is connected to the plurality of expansion nodes via the connector.

24. The method of claim 19, wherein the smart I2C device comprises an I2C master device and an I2C slave device, and the I2C slave device is configured to obtain an address signal via the midpoint board.

25. The method of claim 19, wherein the programmable logic device comprises an input terminal and control terminals,
wherein the input terminal of the programmable logic device is configured to receive a first I2C signal sent by the baseboard management controller, and
wherein one of the control terminals of the programmable logic device is configured to control an enable terminal of the I2C hotswap chip based on the first I2C signal to turn on or off the smart I2C device.

26. The method of claim 19, wherein the I2C hotswap chip comprises an input terminal and an output terminal,
wherein the input terminal of the I2C hotswap chip is configured to receive a second I2C signal sent by the baseboard management controller, and
wherein the I2C hotswap chip turns on or off the smart I2C device based on one of the control terminals of the programmable logic device and the second I2C signal.

27. The method of claim 19, further comprising:
when the I2C bus remains in a hung state after the master node disconnects all the smart I2C devices on the plurality of expansion nodes, sequentially turning on, by the master node, the smart I2C devices on the plurality of expansion nodes to reconnect the smart I2C devices to the I2C bus,
wherein when the I2C bus resumes from hang after a smart I2C device on a current expansion node is turned on, the smart I2C device on the current expansion node is abnormal.

28. The method of claim 19, wherein the master node further comprises a plurality of hotswap buffers, a central processing unit, and a power supply, and
wherein input terminals of the plurality of hotswap buffers are connected to a plurality of I2C interfaces of the baseboard management controller, and output terminals of the plurality of hotswap buffers are connected to the plurality of expansion nodes via the midpoint board.

29. The method of claim 28, wherein the I2C interfaces of the baseboard management controller comprise a first I2C interface and a second I2C interface, and the I2C signal comprises a first I2C signal and a second I2C signal; wherein the first I2C interface is configured to output the first I2C signal, the second I2C interface is configured to output the second I2C signal, and the hotswap buffers comprise a first hotswap buffer and a second hotswap buffer.

30. The method of claim 29, wherein the first I2C signal is input to programmable logic devices on the plurality of expansion nodes via the first hotswap buffer, and the second I2C signal is input to I2C hotswap chips on the plurality of expansion nodes via the second hotswap buffer.
